(19) United States
(12) Patent Application Publication
(10) Pub. No.: US 2014/0269637 A1
(43) Pub. Date: Sep. 18, 2014

(54) DETECTING MISSING RRC CONNECTION RELEASE MESSAGE

(71) Applicant: QUALCOMM Incorporated, San Diego, CA (US)

(72) Inventors: Brian Clarke BANISTER, San Diego, CA (US); Shengshan CUI, San Diego, CA (US); Shivratna Giri SRINIVASAN, San Diego, CA (US)

(73) Assignee: QUALCOMM Incorporated, San Diego, CA (US)

(21) Appl. No.: 14/214,083

(22) Filed: Mar. 14, 2014

Related U.S. Application Data
(60) Provisional application No. 61/801,632, filed on Mar. 15, 2013.

(51) Int. Cl. H04L 5/00; H04W 74/04; H04W 74/08; H04W 72/14

(52) U.S. Cl. CPC H04L 5/0078; H04W 72/14; H04W 74/04; H04W 74/0833
USPC 370/336

(57) ABSTRACT

A method, an apparatus, and a computer program product for wireless communication are provided. The apparatus may be a UE. The UE determines a possibility of failing to receive an RRC connection release message from a network. The UE sends a communication to the network in order to determine whether the UE failed to receive the RRC connection release message. The UE may perform one of maintaining or changing an RRC state based on the communication sent to the network. The UE may maintain an RRC connected state upon determining that the UE did not fail to receive the RRC connection release message from the network. The UE may change from an RRC connected state to an RRC idle state upon determining that the UE failed to receive the RRC connection release message from the network.

### CROSS-REFERENCE TO RELATED APPLICATION(S)

This application claims the benefit of U.S. Provisional Application Ser. No. 61/801,632, entitled “Detecting Missing RRC Connection Release Message” and filed on Mar. 15, 2013, which is expressly incorporated by reference herein in its entirety.

### BACKGROUND

1. Field

The present disclosure relates generally to communication systems, and more particularly, to detecting a missing radio resource control (RRC) connection release message.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided. The apparatus may be a UE. The UE determines a possibility of failing to receive an RRC connection release message from a network. The UE sends a communication to the network in order to determine whether the UE failed to receive the RRC connection release message.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram for illustrating exemplary methods.

FIG. 8 is a flow chart illustrating exemplary methods.

FIG. 9 is a flow chart of a first method of wireless communication.

FIG. 10 is a flow chart of a second method of wireless communication.

FIG. 11 is a flow chart of a third method of wireless communication.

FIG. 12 is a flow chart of a fourth method of wireless communication.

FIG. 13 is a flow chart of a fifth method of wireless communication.

FIG. 14 is a conceptual data flow diagram illustrating the data flow between different modules/means/components in an exemplary apparatus.

FIG. 15 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 includes a Mobility Management Entity (MME) 112, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, an intranet, an IP Multimedia Subsystem (IMS), and a PS Streaming Service (PSS). The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sector). The term “cell” can refer to the smallest coverage area of an eNB and/or an eNB subsystem serving are particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

An RRC connection release message may be signaled to the UE to put the UE into an RRC idle state. If the RRC connection release message is received, the UE releases radio resources, including the RLC entity, the MAC configuration, and the associated PDCP entity for established radio bearers (RBs).

There may be scenarios where the UE may not receive the RRC connection release message. For example, in a suspended-resume LTE (SR-LTE) architecture, LTE and other radio access technologies (RATs) share the same RF chain (e.g., the UE has only one RF chain) and the RF chain may at times tune away from LTE in order to monitor other RATs. For another example, the UE may have a poor channel condition (e.g., a low signal to interference plus noise ratio (SINR)) and may be unable to receive and/or to decode an RRC connection release message. If the RRC connection release message is sent during a period when the UE is unable to receive the RRC connection release message (e.g., when the RF chain is tuned away or the channel condition for the UE is poor), the UE may miss the RRC connection release message. Missing the RRC connection release message may be undesirable because the UE and the network will be out-of-sync (e.g., in terms of their RRC, RLC, and/or MAC states). Under such circumstances, the UE may continue to operate as if the UE is in the RRC connected state, which may adversely impact power consumption by the UE. Therefore, there exists a need for the UE to detect if the UE has missed an RRC connection release message, and to adjust an RRC state based on the detection.

FIG. 7 is a diagram 700 for illustrating exemplary methods. Prior to time A 708, the UE 702 is operating in an RRC connected state with the eNB 704. At time A 708, the UE 702 is unable to receive and/or to decode an RRC connection release message 706. For example, at time A 708, the UE 702 may switch an RF chain from a first RAT (e.g., LTE) to a second RAT (e.g., non-LTE) in order to listen for communication from the second RAT. The first RAT is different from the second RAT. For another example, at time A 708, the UE may move to a location such that the channel between the eNB 704 and the UE 702 is poor. Under both of these circumstances, the UE 702 is unable to receive and/or to decode the RRC connection release message 706.

The RRC connection release message 706 may be sent from the eNB 704 at time B during the time period Tₚ 710 in which the UE 702 is unable to receive/decode the RRC connection release message 706. Subsequent RRC connection release messages 706 may be sent at times B′ and B″. The duration of time in which the UE 702 is unable to receive the RRC connection release message 706 from the eNB 704 begins at time A 708 and extends for a duration Tₚ 710. At time C, the UE 702 may regain the ability to receive the RRC connection release message 706. For example, at time C, the UE 702 may switch back from the second RAT to the first RAT. For another example, at time C 712, the UE 702 may re-enter the radio range of the eNB 704 sending the RRC connection release message 706. Prior to time C 712, the eNB 704 stops sending the RRC connection release message 706.

At time C 712, the UE 702 is still operating in the RRC connected state, as the UE 702 did not receive the RRC connection release message 706. However, the eNB 704 is operating under the incorrect assumption that the UE 702 received the RRC connection release message 706 and that the UE 702 is therefore operating in the RRC idle state.

To detect such a mismatch in the assumed RRC state of the UE 702, the UE 702 may utilize, in part, one or more timers that define one or more time durations. A timer T1 may start at time C 712 and extend for a first time duration Tₐ. A timer T2 may start at time D 714 and extend for a second time duration T_{b} up to a time E 716. The expirations of timer(s) T1 and/or T2 may be adjusted (e.g., the expiration of timer T1 may monotonically increase) so as to adjust corresponding time durations. An exemplary method for detecting a missing RRC connection release message 706 is illustrated in FIG. 8.

FIG. 8 is a flowchart 800 illustrating exemplary methods. In step 802, the UE 702 is in the RRC connected state and a timer T1 is started, thus beginning a first time duration. In step 804, the UE 702 determines whether a DL and/or UL grant has been received before expiration of the timer T1, i.e., was the grant received within the first time duration. If the DL/UL grant has been received before expiration of the timer T1, at step 806, the UE 702 remains in the RRC connected state and resets all timers. If the DL/UL grant has not been received before expiration of timer T1, the UE 702 determines the possibility that the RRC connection release message was missed, and in step 808, starts the timer T2, thus beginning a second time duration. After the timer T2 is started, in step 810, the UE 702 determines whether a scheduling request (SR) PUCCH has been configured. In some circumstances, the network may configure certain SR PUCCH resources to the UE 702 for purposes of requesting an UL grant when new data is received at the UE's MAC buffer. In other circumstances, the network may not configure SR PUCCH resources to the UE 702.

If the UE 702 determines that the SR PUCCH has been configured, at step 812, the UE 702 sends an SR on the PUCCH. Upon reception of the SR on the PUCCH, the eNB 704 may allocate an UL grant (via, e.g., a downlink control information (DCI) format 0 message). If the UE 702 determines that the SR PUCCH has not been configured, at step 814, the UE 702 performs a RACH procedure.

At step 816, the UE 702 determines whether the UE 702 has received a DL/UL grant addressed to or encrypted by a cell radio network temporary identifier (C-RNTI) before the timer T2 expires, i.e., was the particular grant received within the second time duration. If the UE 702 does not receive a DL/UL grant in response to the transmitted SR in the PUCCH in step 812 or the RACH procedure in step 814, the UE 702 releases the RRC connection at step 820. If the UE 702 receives a DL/UL grant in response to the transmitted SR in the PUCCH in step 812 or the RACH procedure in step 814, the UE 702 remains in the RRC connected state and resets timers T1 and T2 at step 806.

One reason for determining whether the UE 702 received the DL/UL addressed to the C-RNTI is to test the validity/availability of the SR PUCCH resource before setting the UE 702 to the RRC idle state. If the eNB 704 is operating under the assumption that the UE 702 is in an RRC idle state, the SR PUCCH resource will be unavailable. If the UE 702 determines that the SR PUCCH resource is available, then the UE 702 can determine that the RRC is in a connected state from the perspective of the eNB 704. Another reason for determining whether the UE 702 received the DL/UL addressed to the C-RNTI is to determine whether contention resolution of the RACH procedure has failed before setting the UE 702 to the RRC idle state. If the eNB 704 cannot recognize the C-RNTI sent on message 3 (also referred to as an L2/L3 message) of the RACH procedure, contention resolution will fail. If contention resolution fails, the UE 702 can determine that the RRC is in a connected state from the perspective of the eNB 704.

FIG. 9 is a flow chart 900 of a first method of wireless communication. The method may be performed by a UE. As shown in FIG. 9, in step 902, the UE determines a possibility of failing to receive an RRC connection release message from a network. In step 904, the UE sends a communication to the network in order to determine whether the UE failed to receive the RRC connection release message. The UE performs one of maintaining or changing an RRC state based on the communication sent to the network. In step 906, the UE determines whether the UE has failed to receive an RRC connection release message from the network. If the UE determines that the UE did not fail to receive the RRC connection release message from the network, in step 908, the UE maintains an RRC connected state. If the UE determines that the UE failed to receive the RRC connection release message from the network, in step 910, the UE changes from an RRC connected state to an RRC idle state.

For example, referring to FIGS. 7 and 8, a UE 702 determines a possibility of failing to receive an RRC connection release message 706 from a network 704. Upon expiration of a first timer T1, the UE 702 sends a communication to the network 704 in order to determine whether the UE 702 failed to receive the RRC connection release message 706. In steps 806, 820, the UE performs one of maintaining or changing an RRC state based on the communication sent to the network 704 in steps 812, 814. The UE 702 determines whether the UE 702 has failed to receive an RRC connection release message 706 from the network 704. If the UE 702 determines that the UE 702 did not fail to receive the RRC connection release message 706 from the network 704 (e.g., the network 704 never sent the RRC connection release message 706), the UE 702 maintains an RRC connected state in step 806. If the UE 702 determines that the UE 702 failed to receive the RRC connection release message 706 from the network 704, the UE 702 changes from the RRC connected state to an RRC idle state in step 820.

FIG. 10 is a flow chart 1000 of a second method of wireless communication. The method may be performed by a UE. As shown in FIG. 10, in step 1002, the UE may adjust an expiration time of a timer in order to adjust a time period between when the communication is sent to the network (in step 904) and a subsequent communication is sent to the network (in step 904) for determining whether the UE failed to receive the RRC connection release message. The UE determines the possibility of failing to receiving an RRC connection release message from the network in step 902, by performing steps 1004-1010. In step 1004, the UE starts a timer. In step 1006, the UE determines whether a grant from the network is received before the timer expires. When a grant from the network is received before expiration of the timer, in step 1008, the UE determines that the RRC connection release message was not sent by the network. When a grant from the network is not received before expiration of the timer, in step 1010, the UE determines the possibility that the RRC connection release message was sent by the network.

For example, referring to FIGS. 7 and 8, the UE 702 may use the expiration time of the timer T1 for determining whether the UE 702 failed to receive the RRC connection release message 706. The first time period Tₐ, corresponding to the duration between time C 712 and time D 714, may be increased and/or decreased. The UE 702 determines the possibility of failing to receive an RRC connection release message 706 from the network 704 based on a first time duration defined using the timer T1. In step 804, the UE 702 determines whether a grant from the network 704 is received before the timer T1 expires, i.e., was the grant received within the first time duration. When a grant from the network 704 is received before expiration of the timer T1, in step 806, the UE 702 remains in the RRC connected state and resets the timer T1. When a grant from the network 704 is not received before expiration of the timer T1, the UE 702 determines the possibility that the RRC connection release message 706 was sent by the network 704.

FIG. 11 is a flow chart 1100 of a third method of wireless communication. The method may be performed by a UE. The UE sends the communication to the network in order to determine whether the UE failed to receive the RRC connection release message in step 904, by performing steps 1102-1110. In step 1102, the UE starts a timer. In step 1104, the UE sends a scheduling request to the network. In step 1106, the UE determines whether a grant is received for the UE based on the scheduling request before expiration of the timer. When a grant from the network is not received before expiration of the timer, in step 1108, the UE assumes that the RRC connection release message was sent by the network. When a grant from the network is received before expiration of the timer, in step 1110, the UE determines that the RRC connection release message was not sent by the network.

For example, referring to FIGS. 7 and 8, the UE 702 may send a communication to the network 704 in order to determine whether the UE 702 failed to receive the RRC connection release message 706. In step 808, the UE starts a timer T2 used to define a second time duration. In step 812, the UE 702 sends a scheduling request to the network 704. In step 816, the UE 702 determines whether a grant is received for the UE 702 based on the scheduling request before expiration of the timer T2, i.e., as the grant received within the second time duration. When a grant from the network 704 is not received before expiration of the timer T2, in step 820, the UE assumes that the RRC connection release message 706 was sent by the network 704. When a grant from the network 704 is received before expiration of the timer T2, in step 806, the UE 702 determines that the RRC connection release message 706 was not sent by the network 704.

FIG. 12 is a flow chart 1200 of a fourth method of wireless communication. The method may be performed by a UE. The UE sends the communication to the network in order to determine whether the UE failed to receive the RRC connection release message in step 904, by performing steps 1202-1210. In step 1202, the UE starts a timer used to define a second time duration. In step 1204, the UE performs a RACH procedure with the network. In step 1206, the UE determines whether a grant is received for the UE based on the RACH procedure before expiration of the timer, i.e., was the grant received within the second time duration. When a grant from the network is not received before expiration of the timer, in step 1208, the UE assumes that the RRC connection release message was sent by the network. When a grant from the network is received before expiration of the timer, in step 1210, the UE determines that the RRC connection release message was not sent by the network.

For example, referring to FIGS. 7 and 8, the UE 702 may send a communication to the network 704 in order to determine whether the UE 702 failed to receive the RRC connection release message 706. In step 808, the UE 702 starts the timer T2. In step 814, the UE 702 performs a RACH procedure with the network 704. In step 816, the UE 702 determines whether a grant is received for the UE 702 based on the RACH procedure before expiration of the timer T2. When a grant from the network 704 is not received before expiration of the timer T2, in step 820, the UE 720 assumes that the RRC connection release message 706 was sent by the network 704. When a grant from the network 704 is received before expiration of the timer T2, in step 806, the UE determines that the RRC connection release message 706 was not sent by the network 704.

FIG. 13 is a flow chart 1300 of a fifth method of wireless communication. The method may be performed by a UE. As shown in FIG. 13, in step 1302, the UE switches from communicating with the network associated with a RAT to listening to a second network associated with a second RAT. In step 1304, the UE switches back to communicating with the network. In step 1306, the UE starts a timer (e.g., the timer T1 used to define a first time duration) upon switching back to communicating with the network. In step 1308, the UE determines whether a grant from the network is received before the timer expires, i.e., was the grant received within the first time duration. In step 1310, the UE determines a possibility of failing to receive an RRC connection release message from a network based on the timer and whether a grant is received from the network before the timer expires. In step 1312, the UE sends a communication to the network and starts a second timer (e.g., the timer T2) in order to determine whether the UE failed to receive the RRC connection release message. As discussed supra, the UE may adjust the timer T1. The UE may alternatively or additionally adjust the timer T2.

For example, referring to FIGS. 7 and 8, the UE 702 may switch from communicating with the network 704 associated with a RAT (e.g., prior to time A 708) to listening to a second network associated with a second RAT (e.g., time period Tₚ 710 between time A 708 and time B 712). At time C 712, the UE 702 switches back to communicating with the network 704. At time C 712, the UE 702 may start a timer T1 upon switching back to communicating with the network 704. In step 804, the UE 702 determines whether a grant from the network 704 is received before the timer T1 expires. The UE 702 determines a possibility of failing to receive an RRC connection release message 706 from a network 704 based on whether a grant is received from the network 704 before the timer T1 expires. The UE 702 sends a communication to the network 704 and starts a second timer T2 in order to determine whether the UE 702 failed to receive the RRC connection release message 706.

FIG. 14 is a conceptual data flow diagram 1400 illustrating the data flow between different modules/means/components in an exemplary apparatus 1402. The apparatus may be a UE. The apparatus may include a receiving module 1404, an RRC state module 1406, a timer module 1408, and a transmission module 1410. The RRC state module 1406 is configured to determine a possibility of failing to receive an RRC connection release message from a network 1450. The RRC state module 1410 is configured to send a communication to the network 1450 in order to determine whether the UE failed to receive the RRC connection release message. The RRC state module 1406 may be configured to perform one of maintaining or changing an RRC state based on the communication sent to the network 1450. The RRC state module 1406 may be configured to maintain an RRC connected state upon determining that the UE did not fail to receive the RRC connection release message from the network 1450. The RRC state module 1406 may be configured to change from an RRC connected state to an RRC idle state upon determining that the UE failed to receive the RRC connection release message from the network 1450. To determine the possibility of failing to receive an RRC connection release message from the network 1450, the RRC state module 1406 may request the timer module 1408 to start a timer (e.g., the timer T1), determine whether a grant from the network 1450 is received by the receiving module 1404 before the timer expires, determine that the RRC connection release message was not sent by the network 1450 when a grant from the network 1450 is received before expiration of the timer, and determine the possibility that the RRC connection release message was sent by the network 1450 when a grant from the network 1450 is not received before expiration of the timer.

The timer module 1408 may be configured to adjust an expiration time of the timer in order to adjust a time period between when the communication is sent to the network 1450 and a subsequent communication is sent to the network 1450 for determining whether the UE failed to receive the RRC connection release message.

To send the communication to the network 1450 in order to determine whether the UE failed to receive the RRC connection release message, the RRC state module 1406 may request the timer module 1408 to start a timer (e.g., the timer T2), request the transmission module 1410 to send a scheduling request to the network 1450, determine whether the receiving module 1404 has received a grant for the UE based on the scheduling request before expiration of the timer, determine that the RRC connection release message was not sent by the network 1450 when a grant from the network 1450 is received before expiration of the timer, and assume that the RRC connection release message was sent by the network 1450 when a grant from the network 1450 is not received before expiration of the timer.

To send the communication to the network 1450 in order to determine whether the UE failed to receive the RRC connection release message, the RRC state module 1406 may request the timer module 1408 to start a timer (e.g., the timer T2), request the transmission module 1410 to perform a RACH procedure with the network 1450, determine whether the receiving module 1404 has received a grant for the UE based on the RACH procedure before expiration of the timer, determine that the RRC connection release message was not sent by the network 1450 when a grant from the network 1450 is received before expiration of the timer, and assume that the RRC connection release message was sent by the network 1450 when a grant from the network 1450 is not received before expiration of the timer.

The receiving module 1404 may be configured to switch from communicating with the network 1450 associated with a RAT to listening to a second network 1450 associated with a second RAT. The receiving module 1404 may be configured to switch back to communicating with the network 1450. The RRC state module 1406 may be configured to request the timer module 1408 to start a timer (e.g., the timer T1) upon switching back to communicating with the network 1450. The RRC state module 1406 may be configured to determine whether the receiving module 1404 has received a grant from the network 1450 before the timer expires. The RRC state module 1406 may be configured to determine the possibility of failing to receive the RRC connection release message from the network 1450 based on the timer and whether a grant is received from the network 1450 before the timer expires.

The apparatus may include additional modules that perform each of the steps of the algorithm in the aforementioned flow charts of FIGS. 8-13. As such, each step in the aforementioned flow charts of FIGS. 8-13 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

FIG. 15 is a diagram 1500 illustrating an example of a hardware implementation for an apparatus 1402′ employing a processing system 1514. The processing system 1514 may be implemented with a bus architecture, represented generally by the bus 1524. The bus 1524 may include any number of interconnecting buses and bridges depending on the specific application of the processing system 1514 and the overall design constraints. The bus 1524 links together various circuits including one or more processors and/or hardware modules, represented by the processor 1504, the modules 1404, 1406, 1408, 1410, and the computer-readable medium 1506. The bus 1524 may also link various other circuits such as timing sources, peripherals, voltage regulators, and power management circuits, which are well known in the art, and therefore, will not be described any further.

The processing system 1514 may be coupled to a transceiver 1510. The transceiver 1510 is coupled to one or more antennas 1520. The transceiver 1510 provides a means for communicating with various other apparatus over a transmission medium. The transceiver 1510 receives a signal from the one or more antennas 1520, extracts information from the received signal, and provides the extracted information to the processing system 1514. In addition, the transceiver 1510 receives information from the processing system 1514, and based on the received information, generates a signal to be applied to the one or more antennas 1520. The processing system 1514 includes a processor 1504 coupled to a computer-readable medium 1506. The processor 1504 is responsible for general processing, including the execution of software stored on the computer-readable medium 1506. The software, when executed by the processor 1504, causes the processing system 1514 to perform the various functions described supra for any particular apparatus. The computer-readable medium 1506 may also be used for storing data that is manipulated by the processor 1504 when executing software. The processing system further includes at least one of the modules 1404, 1406, 1408, 1410. The modules may be software modules running in the processor 1504, resident/stored in the computer readable medium 1506, one or more hardware modules coupled to the processor 1504, or some combination thereof. The processing system 1514 may be a component of the UE 650 and may include the memory 660 and/or at least one of the TX processor 668, the RX processor 656, and the controller/processor 659.

In one configuration, the apparatus 1402/1402′ for wireless communication may be a UE. The UE includes means for determining a possibility of failing to receive a RRC connection release message from a network, and means for sending a communication to the network in order to determine whether the UE failed to receive the RRC connection release message. The UE may further include means for performing one of maintaining or changing an RRC state based on the communication sent to the network. The UE may further include means for maintaining an RRC connected state upon determining that the UE did not fail to receive the RRC connection release message from the network. The UE may further include means for changing from an RRC connected state to an RRC idle state upon determining that the UE failed to receive the RRC connection release message from the network. The means for determining the possibility of failing to receiving an RRC connection release message from the network may be configured to start a timer, to determine whether a grant from the network is received before the timer expires, to determine that the RRC connection release message was not sent by the network when a grant from the network is received before expiration of the timer, and to determine the possibility that the RRC connection release message was sent by the network when a grant from the network is not received before expiration of the timer. The UE may further include means for adjusting an expiration time of the timer in order to adjust a time period between when the communication is sent to the network and a subsequent communication is sent to the network for determining whether the UE failed to receive the RRC connection release message. The means for sending the communication to the network in order to determine whether the UE failed to receive the RRC connection release message may be configured to start a timer, to send a scheduling request to the network, to determine whether a grant is received for the UE based on the scheduling request before expiration of the timer, to determine that the RRC connection release message was not sent by the network when a grant from the network is received before expiration of the timer, and to assume that the RRC connection release message was sent by the network when a grant from the network is not received before expiration of the timer.

The means for sending the communication to the network in order to determine whether the UE failed to receive the RRC connection release message may be configured to start a timer, to perform a RACH procedure with the network, to determine whether a grant is received for the UE based on the RACH procedure before expiration of the timer, to determine that the RRC connection release message was not sent by the network when a grant from the network is received before expiration of the timer, and to assume that the RRC connection release message was sent by the network when a grant from the network is not received before expiration of the timer.

In one configuration, the network is associated with a RAT, and the UE further includes means for switching from communicating with the network to listening to a second network associated with a second RAT different than the RAT, means for switching back to communicating with the network, and means for starting a timer upon switching back to communicating with the network. The possibility of failing to receive the RRC connection release message from the network may be determined based on the timer. The UE may further include means for determining whether a grant from the network is received before the timer expires. The possibility of failing to receive the RRC connection release message from the network may be determined further based on whether a grant is received from the network before the timer expires.

The aforementioned means may be one or more of the aforementioned modules of the apparatus 1402 and/or the processing system 1514 of the apparatus 1402′ configured to perform the functions recited by the aforementioned means. As described supra, the processing system 1514 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication of a user equipment (UE), comprising:
determining whether a grant from a network is received within a first time duration;
determining that a radio resource control (RRC) connection release message was not sent by the network when a grant from the network is received within the first time duration;
determining the possibility that the RRC connection release message was sent by the network when a grant from the network is not received within the first time duration;
sending a communication to the network in order to determine whether the UE failed to receive the RRC connection release message; and
adjusting the first time duration in order to adjust a time period between when the communication is sent to the network and a subsequent communication is sent to the network for determining whether the UE failed to receive the RRC connection release message.

2. The method of claim 1, further comprising performing one of maintaining or changing an RRC state based on the communication sent to the network.

3. The method of claim 2, further comprising maintaining an RRC connected state upon determining that the UE did not fail to receive the RRC connection release message from the network.

4. The method of claim 2, further comprising changing from an RRC connected state to an RRC idle state upon determining that the UE failed to receive the RRC connection release message from the network.

5. The method of claim 1, wherein adjusting the first time duration comprises monotonically increasing the first time duration.

6. The method of claim 1, wherein sending the communication to the network in order to determine whether the UE failed to receive the RRC connection release message comprises:
sending a scheduling request to the network;
determining whether a grant is received for the UE based on the scheduling request within a second time duration;
determining that the RRC connection release message was not sent by the network when a grant from the network is received within the second time duration; and
assuming that the RRC connection release message was sent by the network when a grant from the network is not received within a second time duration.

7. The method of claim 1, wherein the sending the communication to the network in order to determine whether the UE failed to receive the RRC connection release message comprises:
performing a random access channel (RACH) procedure with the network;
determining whether a grant is received for the UE based on the RACH procedure within a second time duration;
determining that the RRC connection release message was not sent by the network when a grant from the network is received within the second time duration; and
assuming that the RRC connection release message was sent by the network when a grant from the network is not received within the second time duration.

8. The method of claim 1, wherein the network is associated with a radio access technology (RAT), and the method further comprises:
switching from communicating with the network to listening to a second network associated with a second RAT; and
switching back to communicating with the network;
wherein the start of the first time duration occurs upon switching back to communicating with the network.

9. An apparatus for wireless communication, the apparatus being a user equipment (UE), comprising:
means for determining whether a grant from a network is received within a first time duration;
means for determining that a radio resource control (RRC) connection release message was not sent by the network when a grant from the network is received within the first time duration;
means for determining the possibility that the RRC connection release message was sent by the network when a grant from the network is not received within the first time duration;
means for sending a communication to the network in order to determine whether the UE failed to receive the RRC connection release message; and
means for adjusting the first time duration in order to adjust a time period between when the communication is sent to the network and a subsequent communication is sent to the network for determining whether the UE failed to receive the RRC connection release message.

10. The apparatus of claim 9, further comprising means for performing one of maintaining or changing an RRC state based on the communication sent to the network.

11. The apparatus of claim 10, further comprising means for maintaining an RRC connected state upon determining that the UE did not fail to receive the RRC connection release message from the network.

12. The apparatus of claim 10, further comprising means for changing from an RRC connected state to an RRC idle state upon determining that the UE failed to receive the RRC connection release message from the network.

13. The apparatus of claim 9, wherein the means for adjusting the first time duration is configured to monotonically increase the first time duration.

14. The apparatus of claim 9, wherein the means for sending the communication to the network in order to determine whether the UE failed to receive the RRC connection release message is configured to:
send a scheduling request to the network;
determine whether a grant is received for the UE based on the scheduling request within a second time duration;
determine that the RRC connection release message was not sent by the network when a grant from the network is received within the second time duration; and
assume that the RRC connection release message was sent by the network when a grant from the network is not received within a second time duration.

15. The apparatus of claim 9, wherein the means for sending the communication to the network in order to determine whether the UE failed to receive the RRC connection release message is configured to:
perform a random access channel (RACH) procedure with the network;
determine whether a grant is received for the UE based on the RACH procedure within a second time duration;
determine that the RRC connection release message was not sent by the network when a grant from the network is received within the second time duration; and
assume that the RRC connection release message was sent by the network when a grant from the network is not received within the second time duration.

16. The apparatus of claim 9, wherein the network is associated with a radio access technology (RAT), and the apparatus further comprises:
means for switching from communicating with the network to listening to a second network associated with a second RAT; and
means for switching back to communicating with the network;
wherein the start of the first time duration occurs upon switching back to communicating with the network.

17. An apparatus for wireless communication, the apparatus being a user equipment (UE), comprising:
a memory; and
at least one processor coupled to the memory and configured to:
determine whether a grant from a network is received within a first time duration;
determine that a radio resource control (RRC) connection release message was not sent by the network when a grant from the network is received within the first time duration;
determine the possibility that the RRC connection release message was sent by the network when a grant from the network is not received within the first time duration;
send a communication to the network in order to determine whether the UE failed to receive the RRC connection release message; and
adjust the first time duration in order to adjust a time period between when the communication is sent to the network and a subsequent communication is sent to the network for determining whether the UE failed to receive the RRC connection release message.

18. The apparatus of claim 17, wherein the processor is configured to perform one of maintaining or changing an RRC state based on the communication sent to the network.

19. The apparatus of claim 18, wherein the processor is configured to maintain an RRC connected state upon determining that the UE did not fail to receive the RRC connection release message from the network.

20. The apparatus of claim 18, wherein the processor is configured to change from an RRC connected state to an RRC idle state upon determining that the UE failed to receive the RRC connection release message from the network.

21. The apparatus of claim 17, wherein to adjusting the first time duration the processor is configured to monotonically increase the first time duration.

22. The apparatus of claim 17, wherein to send the communication to the network in order to determine whether the UE failed to receive the RRC connection release message, the processor is configured to:
send a scheduling request to the network;
determine whether a grant is received for the UE based on the scheduling request within a second time duration;
determine that the RRC connection release message was not sent by the network when a grant from the network is received within the second time duration; and
assume that the RRC connection release message was sent by the network when a grant from the network is not received within a second time duration.

23. The apparatus of claim 17, wherein the to send the communication to the network in order to determine whether the UE failed to receive the RRC connection release message, the processor is configured to:
perform a random access channel (RACH) procedure with the network;
determine whether a grant is received for the UE based on the RACH procedure within a second time duration;
determine that the RRC connection release message was not sent by the network when a grant from the network is received within the second time duration; and
assume that the RRC connection release message was sent by the network when a grant from the network is not received within the second time duration.

24. The apparatus of claim 17, wherein the network is associated with a radio access technology (RAT), and the processor is further configured to:
switch from communicating with the network to listening to a second network associated with a second RAT; and
switch back to communicating with the network;
wherein the start of the first time duration occurs upon switching back to communicating with the network.

25. A computer program product in a user equipment (UE), comprising:
a computer-readable medium comprising code for:
determining whether a grant from a network is received within a first time duration;
determining that a radio resource control (RRC) connection release message was not sent by the network when a grant from the network is received within the first time duration;
determining the possibility that the RRC connection release message was sent by the network when a grant from the network is not received within the first time duration;
sending a communication to the network in order to determine whether the UE failed to receive the RRC connection release message; and
adjusting the first time duration in order to adjust a time period between when the communication is sent to the network and a subsequent communication is sent to the network for determining whether the UE failed to receive the RRC connection release message.

26. The product of claim 25, further comprising code for performing one of maintaining or changing an RRC state based on the communication sent to the network.

27. The product of claim 25, wherein the code for adjusting the first time duration comprises code for monotonically increasing the first time duration.

28. The product of claim 25, wherein the code for sending the communication to the network in order to determine whether the UE failed to receive the RRC connection release message comprises code for:
sending a scheduling request to the network;
determining whether a grant is received for the UE based on the scheduling request within a second time duration;
determining that the RRC connection release message was not sent by the network when a grant from the network is received within the second time duration; and
assuming that the RRC connection release message was sent by the network when a grant from the network is not received within a second time duration.

29. The product of claim 25, wherein the code for sending the communication to the network in order to determine whether the UE failed to receive the RRC connection release message comprises code for:
performing a random access channel (RACH) procedure with the network;
determining whether a grant is received for the UE based on the RACH procedure within a second time duration;
determining that the RRC connection release message was not sent by the network when a grant from the network is received within the second time duration; and
assuming that the RRC connection release message was sent by the network when a grant from the network is not received within the second time duration.

30. The product of claim 25, wherein the network is associated with a radio access technology (RAT), and the product further comprises code for:
switching from communicating with the network to listening to a second network associated with a second RAT; and
switching back to communicating with the network;
wherein the start of the first time duration occurs upon switching back to communicating with the network.
